(19) United States
(12) Patent Application Publication
(10) Pub. No.: US 2007/0219834 A1
(43) Pub. Date: Sep. 20, 2007

(54) SYSTEM AND METHOD FOR TRANSPORTATION CREW LOGISTIC MANAGEMENT

(76) Inventor: Fred Gluckman, Del Mar, CA (US)

Correspondence Address: LATHROP & GAGE LC, 4845 PEARL EAST CIRCLE, SUITE 300, BOULDER, CO, 80301, US

(21) Appl. No.: 11/677,499

(22) Filed: Feb. 21, 2007

Related U.S. Application Data
(60) Provisional application No. 60/775,303, filed on Feb. 21, 2006.
(60) Provisional application No. 60/784,383, filed on Mar. 21, 2006.

(51) Int. Cl. G01C 21/34

(52) U.S. Cl. 705/6

(57) ABSTRACT

A system, method and software product manages transportation crew logistic. An arrival/departure feed provides arrival and departure times of transportation equipment. A crew scheduling system feed provides information of crew members traveling on the equipment and hotels are notified of crew members prior to their arrival. Stored value cards, for use with a plurality of point of sale devices, are issued to each crew member and a Per Diem manager disburses Per Diem amounts to the stored value cards. A reporting manager generates reports of transactions by one or more of: point of sale devices, a card processing center, the arrival notification manager and the Per Diem manager. A database records transactions and data utilized by one or more of: the point of sale devices, the card processing center, an arrival notification manager, the Per Diem manager and the reporting manager.

### RELATED APPLICATIONS

This Application claims priority to U.S. Provisional Patent Application Ser. No. 60/775,303, filed Feb. 21, 2006, and U.S. Provisional Patent Application Ser. No. 60/784,383, filed Mar. 21, 2006, both incorporated herein by reference.

### BACKGROUND

Transportation companies (railways, truckers, airlines, buses, etc.) are, by law, only allowed to have the equipment operators on duty for a certain number of continuous hours before being required to take a break. The law is applied for safety reasons. They often set up sophisticated “relay” schemes to have one qualified equipment operator replace an equipment operator just getting off shift. The equipment operator getting off shift needs a room to rest, which is frequently in the same hotel as the equipment operator who just replaced him. Crew accommodation is complex logistical task that is often outsourced to crew management companies (CMCs), also known as lodging consultant companies. Crew accommodation management is most easily identified with airline crews.

CMCs are highly specialized travel agencies that understand the specific needs of their particular clients and industries. These CMCs are usually small to medium sized companies that have little or no automation capabilities. Services supplied by these CMCs may vary but typically include:
Sourcing and negotiating with hotels to create a directory of approved hotels where crew members stay and outlining the pricing and amenities included in the price.
Relocating a crew member if accommodation for the crew member at the approved hotel is not available, for whatever reason.
Auditing the room night usage (i.e., number of nights and number of rooms used) on behalf of a transportation company or corporate client to assure proper payment.

The task of identifying the number of required rooms per night at a particular location (known as a “relay point”) and the procurement of sufficient rooms on behalf of their transportation clients is usually a first task for a CMC. In order to get preferred rates, the CMC usually guarantees to utilize a certain number of rooms either daily or monthly. These rooms are “block booked” in the computer system which runs the hotel's room scheduling, called the property management system (PMS) hereinafter. For example, “block booking” is the practice of reserving a certain number rooms for a wedding or similar event.

Transportation companies often do not know which equipment operators are traveling since the equipment operator may change, for example, due to one or more of: illness, shift swapping, etc. Therefore, these rooms are not “registered” in the PMS as are other normal reservations, since there is no name “attached” to each room. For the hotel operator, this is a very important and problematic point.

A first problem occurs in identifying the room occupant at check-in. The degree to which the CMC can accurately report and audit room utilization (e.g., to prevent fraud by either the hotel or crew member) is limited by lack of tools and automation. Particularly since the reserved room has no attached name to identify its intended occupant.

Most CMCs send a fax, on a daily basis, to authorized hotels in the form of a “log sheet” to be signed by crew members to confirm use of a room. The log sheet is used by almost every transportation company, world-wide. The log sheet, however, is also a source of many problems. For example:
If the log sheet is not received, the hotel may assume that no crew members are coming and may rent the rooms to other people.
If the log sheet is received but some crew members forget to sign in, the hotel may not get paid for the used rooms.
If the log sheet is lost, the hotel may not get paid.
The use of the log sheet is different from the normal check-in process used by the hotel and causes training, consistency and stress problems at the front desk, particularly when a new employee struggles with the process.

Transport companies currently disperse crew Per Diems by sending a wire or checks (typically overnight) to hotels for distribution to crew members upon their arrival. Thus, the burden of Per Diem distribution to crew falls upon hotel staff, who acquiesce because the hotel does not want to lose the transport companies as clients. Inevitably other guests of the hotel suffer due to the time required to fulfill the Per Diem disbursement.

The existing process for logistic management of crew accommodation causes problems in many areas.

### SUMMARY

In one embodiment, a system manages transportation crew logistic. An arrival/departure feed provides arrival and departure times of transportation equipment to the system. A crew scheduling system feed provides information of crew members traveling on the equipment to the system. The system also includes a plurality of stored value cards, one stored value card being issued to each crew member, a plurality of point of sale devices for reading the stored value cards, a card processing center for processing data received from one or more of the point of sale devices, an arrival notification manager for notifying a hotel of crew members prior to their arrival, based upon the arrival/departure feed and the crew scheduling system feed, a Per Diem manager for disbursing Per Diem amounts to the stored value cards, a reporting manager for generating reports of transactions by one or more of: the point of sale devices, the card processing center, the arrival notification manager and the Per Diem manager, and a database for recording transactions and data utilized by one or more of: the point of sale devices, the card processing center, the arrival notification manager, the Per Diem manager and the reporting manager.

In another embodiment, a method manages transportation crew logistic management. Room reservations are determined for crew members at a hotel based upon arrival departure feed and crew scheduling system feed. The hotel is notified of the names of the crew members for whom the rooms are reserved. Each crew member is identified upon arrival at the hotel by reading data from a stored value card of each crew member. Payment is received at the hotel based upon the data.

In another embodiment, a software product has instructions, stored on computer-readable media, wherein the instructions, when executed by a computer, perform steps for transportation crew logistic management, including: instructions for determining room reservations for crew members at a hotel based upon arrival departure feed and crew scheduling system feed, instructions for notifying the hotel of the names of the crew members for whom the rooms are reserved, instructions for identifying each crew member upon arrival at the hotel by reading data from a stored value card of each crew member, and instructions for receiving payment at the hotel based upon the data.

### BRIEF DESCRIPTION OF THE FIGURES

FIG. 1 shows one TravelTrax system for transportation crew logistic management.

### DETAILED DESCRIPTION OF THE FIGURES

In the post “911” environment the need is greater than ever for transport companies to know which of their employees is operating their equipment, and/or traveling on it. For example, airlines need to track flight crew (i.e., pilots, cabin staff, etc.) and railroad companies need to track rail crew (i.e., train drivers, traveling staff etc.). Where the crew is required to ‘layover’ away from home, accommodation must be provided and Per Diem arranged for each member of the crew. Transportation companies may utilize crew scheduling software to track and record names of crew members and their destinations.

A system, hereinafter sometimes referred to as “TravelTrax” and “TravelTrax system”, is provided for transportation crew logistic management.

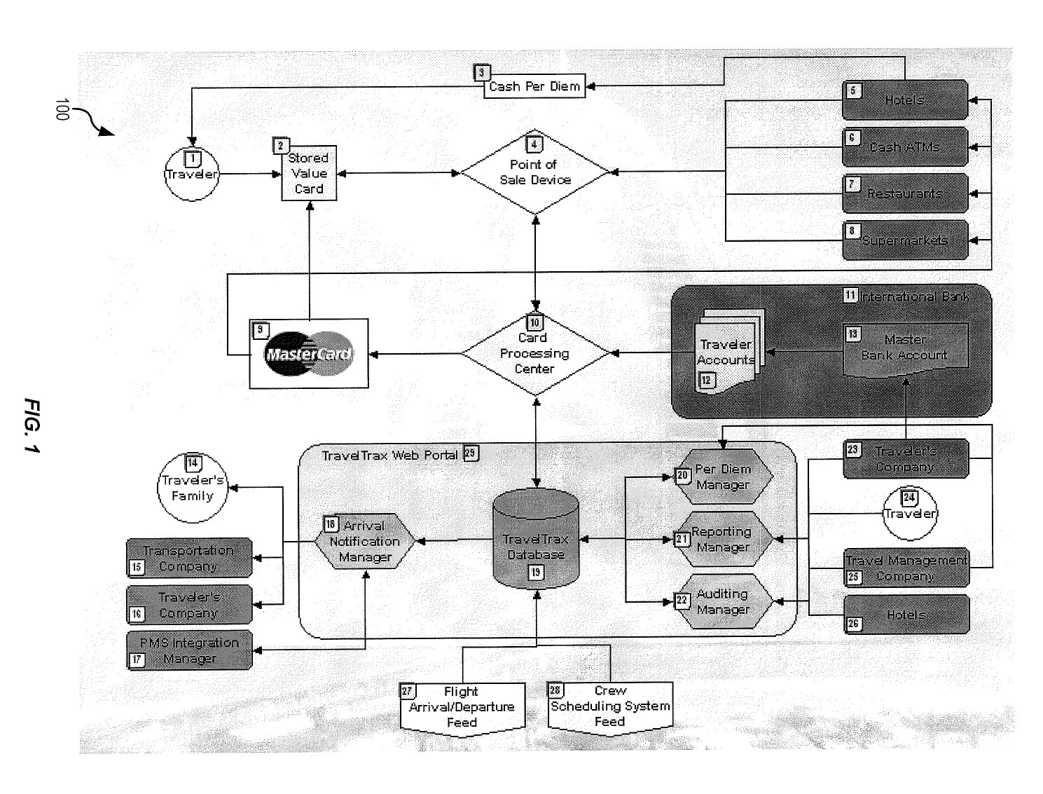

FIG. 1 is a block diagram illustrating one exemplary TravelTrax system 100 for transportation crew logistic management. Traveler 1 represents a crew member. Stored Value Card 2 represents a MasterCard (or other) branded stored value card that is compatible with all point of sale devices. Each traveler 1 has a stored value card 2. Cash Per Diem 3 represents a cash portion of traveler 1's Per Diem. Point of Sale Device 4 represents a physical card reader as located in hotels, ATM machines, restaurants, supermarkets etc. Hotels 5 represent locations where traveler 1 may stay and is a repository for a traveler's cash Per Diem. Cash ATMs 6 represent locations where traveler 1 may use stored value card 2. Restaurants 7 represent locations where traveler 1 may use stored value card 2 while dining. Supermarkets 8 represent locations where traveler 1 may use stored value card 2 to purchase provisions, etc. Distributor 9 (e.g., MasterCard) represents a distributor of stored value card 2 and may be a clearinghouse for reimbursing and tracking transactions made through point of sale devices 4 and/or may be a franchiser responsible for qualifying Banks as franchisees.

Card Processing Center 10 represents a central card processor. It requests card swipe approvals from banks and forwards transaction status and transaction amounts to distributor 9 (e.g., MasterCard) for reporting and accounting. International Bank 11 may manage traveler accounts (e.g., traveler accounts 12) as well as a master bank account 13 which pushes appropriate monies to constituent traveler accounts 12. The bank may also be part of the franchisee agreement with distributor 9 (e.g., MasterCard). Traveler Account 12 represents a traveler's (e.g., traveler 1's) account with the bank to manage balances on their stored value card 2. Master Bank Account 13 represents a bank account with a float cash that is dispersed to a traveler's individual accounts 12 based on a set of per diem rules set by the traveler's company. Although shown within international bank 11, traveler account 12 and master bank account 13 may reside within different banks without departing from the scope hereof.

Traveler's Family 14 represents recipients of traveler 1's arrival notification. Transportation Company 15 represents a transportation company, such as one or more of: cab, limo and shuttle service, which may receive traveler 1's arrival notification to manage pickup and delivery times between airport (or any traveler destination) and reserved hotel 5. Traveler's Company 16 represents a transportation company for whom traveler 1 works and that receives notification of traveler 1's arrival for safety, security, auditing and scheduling purposes.

PMS Integration Manager 17 represents an integration manager for receiving notification of traveler 1's arrival so it can pass this information into the reserved hotel's PMS for check-in streamlining as well as travel auditing and reporting. Arrival Notification Manager 18 polls Flight Arrival/Departure Feed and compares this data to alerts set through the reporting manager and crew scheduling system. When an alert condition is met (e.g., Traveler 1 is about to arrive at Destination B) notifications are sent to ‘interested’ parties via phone, fax, email or text message. TravelTrax Database 19 represents a secure (i.e., using redundant hardware) data storage device for all transactions and data used in TravelTrax system 100.

Per Diem Manager 20 allows Traveler's Company 16, or a crew management company (CMC), to set Per Diem rules that determine how much and under what conditions Per Diems are issued to traveler 1 via the stored value card 2. Reporting Manager 21 allows authorized parties to create and view a variety of system metrics and data. Conditions may also be set to trigger message or data output as in the case of arrival notifications. Auditing Manager 22 allows all parties involved to export information pertinent to auditing room night volumes, Per Diem dispersal, arrival/departure information etc.

Traveler's Company 23 represents the portion of traveler 1's company that controls setting alerts, configuring per diem for their travelers. (In one embodiment Traveler's company 16 and Traveler's company 23 are the same.) Traveler's company 23 has access to all modules of TravelTrax Portal 29 and may determine who else has access to information relating to traveler's company 23. Traveler 24 represents the ability of traveler 1 to report on past per diem dispersals, current balances, etc. Traveler 1 and traveler 24 may be the same. Travel Management Company 25 represents a travel management company (or CMC) with the same capabilities as the Traveler's company to allow them to take over these duties if contracted to do so. Hotels 26 represent the ability of hotels 5 to have access to reporting and auditing information that pertains directly to the usage of their property. Hotels 5 and hotels 26 may be the same. This may include proprietary Per Diem dispersal, room night volumes etc.

Flight Arrival/Departure Feed 27 represents an online, real time feed that may be queried for information about airline (or other transportation methods of the transportation company) departure times, estimated arrival times, actual arrival times, etc. Crew Scheduling System Feed 28 represents a bridge between traveler 1's company's crew scheduling system and TravelTrax system 100. For example, crew scheduling system feed 28 may provides access to equipment traveler 1 will be traveling (and/or operating) on, where and at what times etc. In the case of air travel, it may include flight information, etc. TravelTrax Web Portal 29 represents an online portal that contains all relevant portions of TravelTrax System 100 including user credentialing, data storage, management interfaces, generalized logic, etc.

TravelTrax system 100 may exchange information with crew scheduling software to determine names of crew members and their destinations. For example, a flight management system may send information of flight crew members traveling on each flight to TravelTrax system 100 via flight arrival/departure feed 27. This information may then be utilized by TravelTrax system 100, through a procurement component (e.g., SwiftBid), to locate and reserve accommodation for crew members. Other procurement components may be used without departing from the scope hereof. TravelTrax system 100 may send information of crew members to certain hotel property management systems (PMS), thereby assigning crew members, by name, to reserved hotel rooms.

Where a transportation company utilizes a crew management company (CMC) to manage crew logistics, TravelTrax system 100 will allow CMC's or their actual clients to load Per Diem monies directly onto stored value card 2 either prior to traveler 1's flight or upon arrival of the flight. These loaded funds may be used for hotel incidentals and since stored value card 2 is a MasterCard, in this example, funds can also be spent anywhere MasterCard is accepted.

As noted above, TravelTrax system 100 may integrate (e.g., using an XML bridge) with crew scheduling software. TravelTrax database 19 may store specific traveler information relevant to any particular flight. Thus, TravelTrax system 100 will know, or be able to determine, which crew members are on any given transit (i.e., flight). TravelTrax system 100 may also utilize Airplane Tracking software (e.g., as used by Expedia, Orbitz etc.) to identify flight statuses.

TravelTrax system 100 may take stored crew (flight) information and deliver that directly into a PMS system of hotel 5 via PMS integration manager 17. Thereby, hotels will know the name of the crew member who is coming (i.e., TravelTrax system 100 may modify the block booked room “name” field to show the name of the crew member prior to the arrival of the crew member). Therefore, when the crew member arrives at the hotel, they can be processed in the same manner as any other guest arrival (i.e., hotel staff will not need to rummage around looking for a log sheet).

TravelTrax system 100, utilizing arrival notification manager 18, may be capable of delivering “flight status” alert calls directly to the cell phone of the hotel shuttle driver, thereby eliminating shuttle down time resultant from late or early flight arrivals. Again, overall hotel guest satisfaction improves reducing the chance of missing a flight because a hotel shuttle driver didn't arrive in time.

Each traveler 1 that operates within TravelTrax system 100 has a stored value card 2 (that is also a MasterCard, for example) which is presented to a hotel front desk upon check-in. An attendant at the front desk swipes stored value card 2 and travelers name, hotel and check-in and check-out times are all automatically recorded within TravelTrax system 100. TravelTrax system 100 and stored value card 2 thereby remove any need to maintain log sheets for each transportation company within each hotel used by the transportation company. TravelTrax system 100 may provide hotels and transportation companies (or CMCs) with the following advantages.

Since the swiped card records all check-ins and check-outs, detailed utilization reports may be delivered by TravelTrax system 100 directly to hotel 5 accounting staff. This facilitates auditing and accounting within hotel 5. Since stored value card 2 may also be used for incidental purchases within the hotel, hotel staff need not worry about crew members leaving with unpaid balances. Per Diem (described below) amounts may be loaded directly onto stored value card 2, eliminating the need for cash disbursements or wire transfers. TravelTrax system 100's unique flight tracking software allows “flight status” phone calls to be made directly to the cell phone of the hotel shuttle driver, thereby eliminating shuttle down time resultant from late or early arrivals. Thus, since the workload imposed upon the hotel by the prior art log sheet system is removed, overall guest satisfaction may improve.

Transportation companies (or CMCs) utilizing TravelTrax system 100 no longer need send checks or wire transfers to hotels for Per Diem payments to arriving crew members. The transportation company may load Per Diem funds directly onto TravelTrax stored value cards 2 whenever they wish. Instead of manually faxing log sheets to hotels and paying for the costly, redundant data entry associated with returned log sheets, transportation companies (or CMCs) may receive real-time reports directly from TravelTrax system 100. Thus, transportation companies (or CMCs) no longer have to worry about fraudulent or tampered log sheets. The real time reports show only room utilization resulting from traveler 1's stored value card 2 being swiped (i.e., read) during check-in at the hotel, and thus the transportation companies pay only for rooms actually used.

With TravelTrax system 100, cash Per Diem disbursements practically disappear, reducing concerns for security to crew members and hotels that would otherwise handle these cash Per Diem disbursement. For example, airlines making cash Per Diem payments are increasingly concerned about criminals that learn of crew members receiving large cash disbursements upon check-in to hotels, particularly where the airline makes flights to hundreds of international cities. The use of TravelTrax system 100 and stored value cards 2 may eliminate any need for cash Per Diem disbursement.

The following operational, non-limiting examples relate to FIG. 1.

Traveler Check-In/Per Diem Dispersal

Traveler 1 presents stored value card 2 at hotel 5, where stored value card 2 is swiped through point of sale device 4. Thus, traveler 1 is checked into hotel 5. Point of sale device 4 sends data read from stored value card 2 to card processing center 10, which may check fund availability in travel account 12 of traveler 1. Card processing center 10 sends data to distributor 9 (e.g., MasterCard) of stored value card 2 and to TravelTrax database 19. A cash Per Diem 3 may be returned from hotel 5 to traveler 1 if authorized by traveler's company 23.

Stored Value Card Usage—Retail Purchase or Cash Dispersal

Traveler 1 presents stored value card 2 at hotel 5 upon check-in, cash ATMs 6, restaurants 7, supermarkets 8 or any owner of point of sale device 4. Stored value card 2 is processed through point of sale device 4, which sends data read from stored value card 2 to card processing center 10. Card processing center 10 checks fund availability in traveler account 12 of traveler 1 and responds to point of sale device 4 with success/failure of fund availability. Thus, a retail or cash transaction is approved, products are purchased, cash is dispersed, etc. Card processing center 10 then sends data to distributor 9 (e.g., MasterCard), who receives funds from traveler account 12. Hotels 5, ATMs 6, restaurants 7 and supermarkets 8 etc., may receive funds from distributor 9.

Per Diem Allocation

Traveler's company 23 logs into Per Diem manager 20 and sets Per Diem rules and limits. TravelTrax web portal 29 periodically compares data from crew scheduling system feed 28 with data from flight arrival/Departure feed 27. When a crew member's scheduled flight departs, TravelTrax web portal 29 makes a transfer request from master bank account 13 to traveler's account 12 through card processing center 10. Rules set through Per Diem manager 20 determine what balance is transferred from master bank account 13 to each individual traveler's account 12.

Traveler Arrival Notification

Traveler's company 23, traveler 24, travel management company 25 or hotels 26 log into reporting manager 21 (dependant on system permissions granted to traveler's company 23, traveler 24, travel management company 25 or hotels 26) to set alerts to go to traveler's family 14, transportation company 15, traveler's company 16 and PMS integration manager 17. Notification arrival manager 18 periodically compares data from reporting manager 21, flight arrival/departure feed 27 and crew scheduling system feed 28. When an alert is triggered, traveler's family 14, transportation company 15, traveler's company 16 and PMS integration manager 17 receive a tailored message from arrival notification manager 18. For example, an alert can be set to different trigger levels (e.g., flight arrival, flight arrival—10 minutes, etc.) and tailored messages including one or more of email, fax, text and phone contact may be created.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A system for transportation crew logistic management, comprising:
an arrival/departure feed for providing arrival and departure times of transportation equipment;
a crew scheduling system feed for providing information of crew members traveling on the equipment;
a plurality of stored value cards, one stored value card being issued to each crew member;
a plurality of point of sale devices for reading the stored value cards;
a card processing center for processing data received from one or more of the point of sale devices;
an arrival notification manager for notifying a hotel of crew members prior to their arrival, based upon the arrival/departure feed and the crew scheduling system feed;
a Per Diem manager for disbursing Per Diem amounts to the stored value cards;
a reporting manager for generating reports of transactions by one or more of:
the point of sale devices, the card processing center, the arrival notification manager and the Per Diem manager; and
a database for recording transactions and data utilized by one or more of: the point of sale devices, the card processing center, the arrival notification manager, the Per Diem manager and the reporting manager.

2. The system of claim 1, further comprising an auditing manager for auditing transactions and data within the database.

3. The system of claim 1, wherein the stored value card functions as a MasterCard.

4. A method for transportation crew logistic management, comprising:
determining room reservations for crew members at a hotel based upon arrival departure feed and crew scheduling system feed;
notifying the hotel of the names of the crew members for whom the rooms are reserved;
identifying each crew member upon arrival at the hotel by reading data from a stored value card of each crew member; and
receiving payment at the hotel based upon the data.

5. The method of claim 4, further comprising transferring Per Diem monies to the stored value cards of each crew member upon arrival.

6. The method of claim 4, further comprising notifying, based upon the arrival departure feed and crew scheduling system feed, one or more of the crew member's company, a crew management company, a shuttle driver and a transportation company, of the arrival of each crew member.

7. A software product comprising instructions, stored on computer-readable media, wherein the instructions, when executed by a computer, perform steps for transportation crew logistic management, comprising:
instructions for determining room reservations for crew members at a hotel based upon arrival departure feed and crew scheduling system feed;
instructions for notifying the hotel of the names of the crew members for whom the rooms are reserved;
instructions for identifying each crew member upon arrival at the hotel by reading data from a stored value card of each crew member; and
instructions for receiving payment at the hotel based upon the data.

8. The software product of claim 7, further comprising instructions for transferring Per Diem monies to the stored value cards of each crew member upon arrival.

9. The software product of claim 7, further comprising instructions for notifying, based upon the arrival departure feed and crew scheduling system feed, one or more of the crew member's company, a crew management company, a shuttle driver and a transportation company, of the arrival of each crew member.
